(19) United States
(12) Patent Application Publication
(10) Pub. No.: US 2009/0051884 A1
(43) Pub. Date: Feb. 26, 2009

(54) PROJECTION APPARATUS

(75) Inventors: Da-Shuang Kuan, Hsinchu County (TW); Tony Whitehead, Hsinchu City (TW); Chia-Te Lin, Hsinchu County (TW)

Correspondence Address: J C PATENTS, INC., 4 VENTURE, SUITE 250, IRVINE, CA, 92618, US

(73) Assignee: UNITED MICROELECTRONICS CORP., Hsinchu (TW)

(21) Appl. No.: 11/842,366

(22) Filed: Aug. 21, 2007

(51) Int. Cl. G03B 21/20

(52) U.S. Cl. 353/84

(57) ABSTRACT

A projection apparatus including an illumination system, a reflective light valve, a projection lens, and a color filter is provided. The illumination system has a light source for providing an illumination beam, and the reflective light valve is disposed on the transmission path of the illumination beam. The reflective light valve has a plurality of pixels arranged in an array for converting the illumination beam into an image, and the projection lens is disposed on the transmission path of the image. The color filter is disposed between the light source and the reflective light valve and on the transmission path of the illumination beam. Moreover, the color filter includes a transparent substrate and a color filter array disposed on a first surface of the transparent substrate. The color filter array includes a plurality of filter patterns, and each of the filter patterns corresponds to one of the pixels, respectively.

### BACKGROUND OF THE INVENTION

1. Field of Invention

The present invention relates to a display apparatus. More particularly, the present invention relates to a projection apparatus.

2. Description of Related Art

Recently, the bulky cathode ray tube (CRT) projector has been replaced by liquid crystal display (LCD) projector and digital light processing (DLP) projector. These products have the characteristics such as slimness, lightness, and high portability, and which can be directly connected to digital products to display images. With the manufacturers constantly promoting more competitive products of lower price and adding new additional functions to the products, these products have started to be used in our homes besides being used in companies, schools, and in public.

Generally speaking, to increase the price competitive ability of the projector, the design of single light valve is usually adopted in the projectors on the market, and the projectors with single light valve usually use a time-sequential filter (for example, color wheel) for dividing white light into red light, blue light, and green light in sequence. FIG. 1A is a diagram of a conventional projection apparatus with single reflective light valve. FIG. 1B is a diagram of the color wheel in FIG. 1A. Referring to FIG. 1A and FIG. 1B, in the conventional projection apparatus 100, after the white light 112 provided by the light source 110 passes through the collimation optics 115, it (the white light 112) is reflected by the reflective mirror 120 to the color wheel 130. The color wheel 130 includes a red filter 132, a green filter 134, and a blue filter 136, and the white light 112 can be converted into red light, green light, and blue light in sequence by rotating the color wheel 130. Next, the reflective light valve 140 is driven to present different status sequentially such that the red light, the green light and the blue light produced by the color wheel and reflected by the dichroic mirror 135 can be converted into red image light, green image light, and blue image light by the reflective light valve 140 in sequence. After that, the projection lens 150 projects the red image light, the green image light, and the blue image light onto the screen so as to display a full color image on the screen.

However, errors may be induced while the reflective light valve 140 is driven to present different status to generate the red image, the green image, and the blue image. For example, the status of the reflective light valve 140 should be switched timely when the white light 112 passed through the boundary between the red filter 132 and the green filter 134 of the rotating color wheel 130. Actually, the timing of the reflective light valve 140 switching status may be advanced or delayed, so that rainbow effect may be induced and which will deteriorate the display quality. In addition, since there is only an image with single color is projected onto the screen at a sub-frame time, the light utilization efficiency thereof is not ideal, which results in low image brightness. Moreover, the color wheel 130 is a moving part and the reliability thereof is not as good as immovable part, thus, malfunction may be induced.

FIG. 2 is a diagram illustrating the illumination system and light valve of a conventional projection apparatus. Referring to FIG. 2, the white light 202 provided by the light source 200 becomes a collimated white light 206 after it passes through the collimation optics 204. Next, the filter 302 converts the collimated white light 206 into red light 304R, green light 304G, and blue light 304B, which are spatially separated and have different bandwidths. The switchable optics system 308 is used for respectively focusing the red light 304R, green light 304G, and blue light 304B onto the display surfaces 214A, 214B, and 214C of the light valve 212.

Specifically, the display surface of the light valve 212 can be divided into three blocks (i.e. display surfaces 214A, 214B, and 214C), and the switchable optics system 308 can be switched in three-stage cycle. When switched to the first stage, the switchable optics system 308 respectively projects the red light 304R, the green light 304G, and the blue light 304B onto the display surfaces 214C, 214A, and 214B; when switched to the second stage, the switchable optics system 308 respectively projects the red light 304R, the green light 304G, and the blue light 304B onto the display surfaces 214A, 214B, and 214C; when switched to the third stage, the switchable optics system 308 respectively projects the red light 304R, the green light 304G, and the blue light 304B onto the display surfaces 214B, 214C, and 214A.

In the foregoing architecture, the light utilization efficiency can be improved since three color lights are projected onto the light valve 212 at a sub-frame time (e.g. the time during the first stage, the second stage or the third stage). However, since the driving mechanism of the foregoing architecture is complicated, the manufacturing cost is relatively high. Moreover, the switchable optics system 308 is also a moving part, so that the reliability thereof is inferior to an immovable part. Accordingly, malfunctions may be induced.

### SUMMARY OF THE INVENTION

Accordingly, the present invention is directed to provide a projection apparatus for improving rainbow effect and enhancing display quality.

According to another aspect of the present invention, a projection apparatus is provided for improving product reliability.

To achieve the aforementioned and other objectives, the present invention provides a projection apparatus including an illumination system, a reflective light valve, a projection lens, and a color filter. Wherein the illumination system has a light source for providing an illumination beam, and the reflective light valve is disposed on the transmission path of the illumination beam. The reflective light valve has a plurality of pixels arranged in an array for converting the illumination beam into an image, and the projection lens is disposed on the transmission path of the image. The color filter is disposed between the light source and the reflective light valve and on the transmission path of the illumination beam. Moreover, the color filter includes a transparent substrate and a color filter array disposed on a first surface of the transparent substrate. The color filter array includes a plurality of filter patterns and each of the filter patterns corresponds to one of the foregoing pixels, respectively.

In an embodiment of the present invention, the foregoing filter patterns include a plurality of first color filter patterns, a plurality of second color filter patterns, and a plurality of third color filter patterns.

In an embodiment of the present invention, the foregoing color filter further includes an anti-reflection coating disposed on a second surface of the transparent substrate, and the second surface is opposite to the first surface.

In an embodiment of the present invention, the foregoing filter patterns comprise inorganic material.

In an embodiment of the present invention, the foregoing filter patterns comprise a plurality of stacked dichroic films or pigment material.

In an embodiment of the present invention, each of the foregoing filter patterns and each of the foregoing pixels are similar figures.

In an embodiment of the present invention, the foregoing illumination system further includes a condenser disposed between the color filter and the reflective light valve. The condenser is suitable for focusing the lights passed through the filter patterns of the color filter onto the corresponding pixels.

In an embodiment of the present invention, the foregoing projection apparatus further includes a beam splitter disposed between the color filter, the reflective light valve, and the projection lens.

In an embodiment of the present invention, the foregoing reflective light valve includes digital micro-mirror device (DMD) or liquid crystal on silicon panel (LCOS panel).

The present invention further provides a projection apparatus including an illumination system, a reflective light valve, a projection lens, and a color filter. Wherein the illumination system has a light source for providing an illumination beam. The reflective light valve is disposed on the transmission path of the illumination beam, and the reflective light valve has a plurality of pixels arranged in an array for converting the illumination beam into an image. The projection lens is disposed on the transmission path of the image, and the color filter is disposed between the reflective light valve and the projection lens and on the transmission path of the image. The color filter includes a transparent substrate and a color filter array disposed on a first surface of the transparent substrate. The color filter array includes a plurality of filter patterns, and each of the filter patterns corresponds to one of the foregoing pixels, respectively.

In an embodiment of the present invention, the foregoing filter patterns include a plurality of first color filter patterns, a plurality of second color filter patterns, and a plurality of third color filter patterns.

In an embodiment of the present invention, the foregoing color filter further includes an anti-reflection coating disposed on a second surface of the transparent substrate, and the second surface is opposite to the first surface.

In an embodiment of the present invention, the material of the foregoing filter patterns is inorganic material.

In an embodiment of the present invention, the foregoing filter patterns are formed by stacking dichroic films or from pigment material.

In an embodiment of the present invention, the foregoing reflective light valve includes DMD or LCOS panel.

According to the color filter in the present invention, a white light can be filtered into lights of different colors at a sub-frame time, and these lights are simultaneously projected on the corresponding pixels, thus, the rainbow effect can be effectively improved and the light utilization efficiency can be increased. Moreover, the product has high reliability since the color filter is an immovable part.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a diagram of a conventional projection apparatus with single reflective light valve.

FIG. 1B is a diagram of the color wheel in FIG. 1A.

FIG. 2 is a diagram illustrating the illumination system and light valve of a conventional projection apparatus.

FIG. 3 is a diagram of a projection apparatus according to an embodiment of the present invention.

FIG. 4A is a partial top view of the reflective light valve in FIG. 3.

FIG. 4B is a partial top view of the color filter in FIG. 3.

FIG. 5 is a diagram of a projection apparatus according to another embodiment of the present invention.

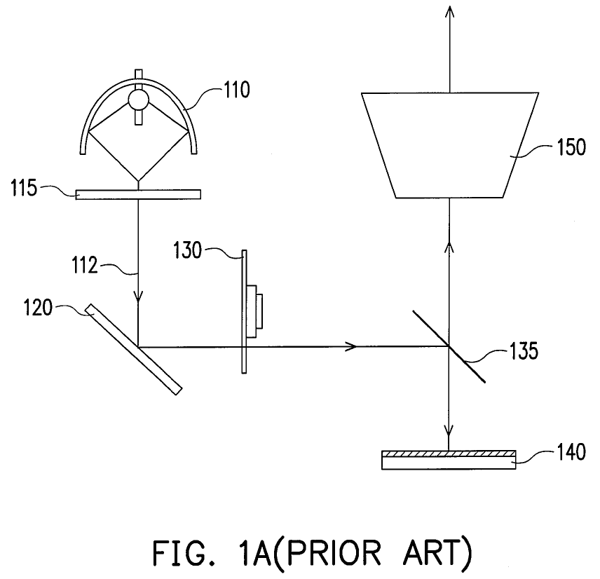

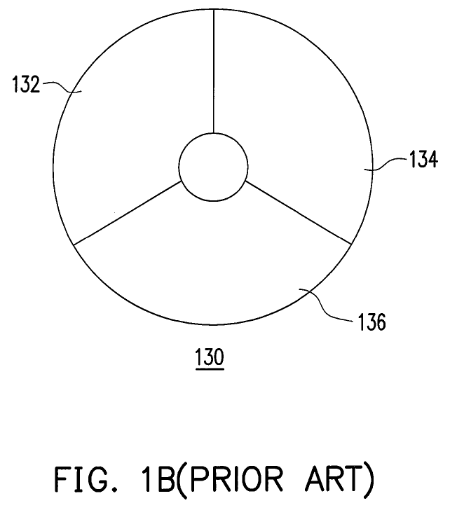

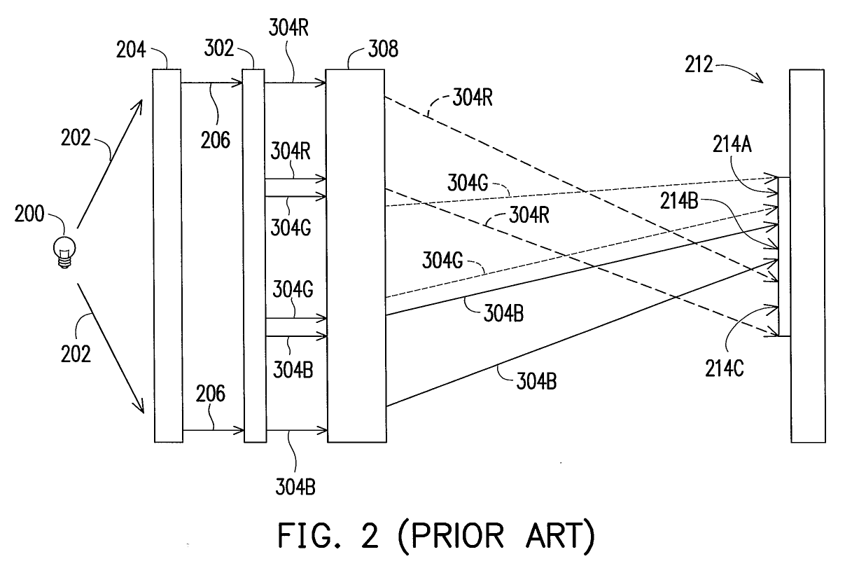

### DESCRIPTION OF EMBODIMENTS

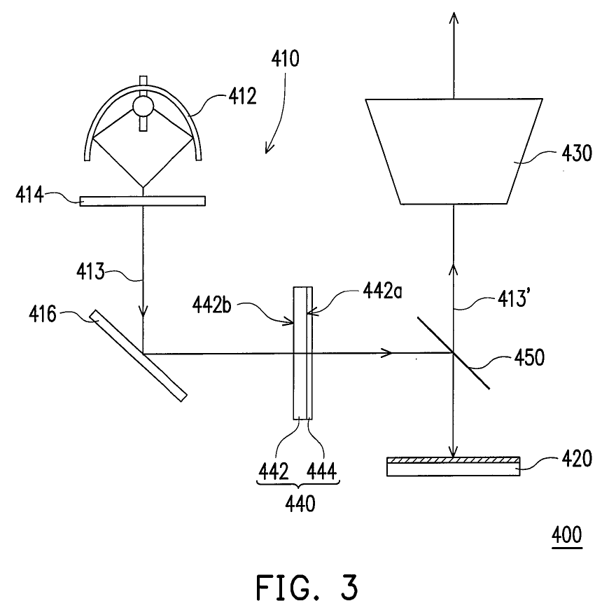

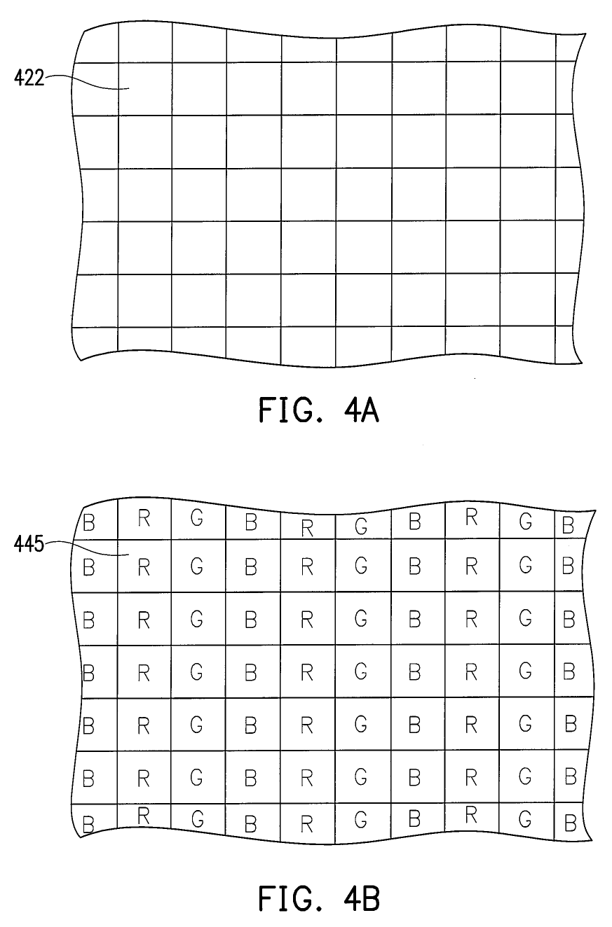

FIG. 3 is a diagram of a projection apparatus according to an embodiment of the present invention, FIG. 4A is a partial top view of the reflective light valve in FIG. 3, and FIG. 4B is a partial top view of the color filter in FIG. 3. Referring to FIG. 3, FIG. 4A, and FIG. 4B, the projection apparatus 400 of the present embodiment includes an illumination system 410, a reflective light valve 420, a projection lens 430, and a color filter 440. The illumination system 410 has a light source 412 for providing an illumination beam 413, and the reflective light valve 420 is disposed on the transmission path of the illumination beam 413. The reflective light valve 420 has a plurality of pixels 422 arranged in an array for converting the illumination beam 413 into an image 413′, and the projection lens 430 is disposed on the transmission path of the image 413′. The color filter 440 is disposed between the light source 412 and the reflective light valve 420 and on the transmission path of the illumination beam 413. Moreover, the color filter 440 includes a transparent substrate 442 and a color filter array 444 disposed on a first surface 442a of the transparent substrate 442. The color filter array 444 includes a plurality of filter patterns 445, and each of the filter patterns 445 corresponds to one of the foregoing pixels 422, respectively. In particular, the number of the filter patterns 445 may be substantially the same as the number of the pixels 422, each filter pattern 445 corresponds to different pixel 422, and the light passed through each of the filter patterns 445 is projected on one of the pixels 422 that is corresponding to the filter pattern 445.

In the foregoing projection apparatus 400, the transparent substrate 442 is, for example, glass substrate, a quartz substrate, or other similar materials. The filter patterns 445 may have many colors, and in the present embodiment, filter patterns of three colors, i.e. first color filter pattern R, second color filter pattern G, and third color filter pattern B, are used as example. The color of the first color filter pattern is, for example, red, the color of the second color filter pattern G is, for example, green, and the color of the third color filter pattern B is, for example, blue. It should be noted that the arrangement of the filter patterns of various colors in FIG. 4B is only used for illustration, but not for limiting the present invention. In addition, the filter patterns 445 can be formed by stacking dichroic films or from pigment material. Moreover, to prevent the filter patterns 445 from deteriorating resulted from irradiation of the illumination system 410, the material of the filter patterns 445 can be inorganic material.

As described above, the illumination system 410 may further include a plurality of optical components, such as the collimation optics 414 and the reflective mirror 416 illustrated in FIG. 3. It should be understood by those skilled in the art that the illumination system 410 may also include other related optical components, which will not be described here.

In the present embodiment, the illumination beam 413 provided by the light source 412 becomes a collimated illumination beam after it passes through the collimation optics 414, and the reflective mirror 416 reflects the illumination beam 413 to the color filter 440. Next, the filter patterns 445 of the color filter 440 conver the illumination beam 413 into red light, green light, and blue light, and the lights passed through the filter patterns 445 are projected on the pixels 422 corresponding to the filter patterns 445. The pixels 422 convert the lights projected thereon into an image 413′ according to the image data to be displayed and reflect the image 413′ to the projection lens 430, and the projection lens 430 projects the image 413′ onto a screen so as to display the image on the screen.

As described above, in the present embodiment, the light passed through the color filter 440 is reflected to the reflective light valve 420 through, for example, a beam splitter 450 disposed between the color filter 440, the reflective light valve 420, and the projection lens 430. The beam splitter 450 may be a dichroic mirror (DM) or a total internal reflection prism (TIR prism). Besides, the reflective light valve 420 may be a digital micro-mirror device (DMD) or a liquid crystal on silicon panel (LCOS panel).

In an embodiment of the present invention, to prevent reflection when the illumination beam 413 passes through the transparent substrate 442 of the color filter 440, an anti-reflection (AR) coating (not shown) can be disposed on a second surface 442b opposite to the first surface 442a of the transparent substrate 442. The material of the anti-reflection coating includes titanium nitride, silicon oxide, silicon oxynitride, or silicon rich nitride.

It should be noted that to simplify the fabrication of the filter patterns 445 of the color filter 440, the size of each filter pattern 445 can be magnified, that is, the filter patterns 445 of the color filter 440 may be larger than the pixels 422 of the reflective light valve 420. In this case, the lights passed through the filter patterns 445 of the color filter 440 should be focused onto the corresponding pixels 422 through a condenser (not shown) disposed between the color filter 440 and the reflective light valve 420.

In the present embodiment, since the color filter 440 can filter the white light provided by the light source 412 into red light, blue light, and green light at a sub-frame time, and these lights of different colors are simultaneously projected onto the corresponding pixels 422, thus, the rainbow effect induced in the conventional technology using time-sequential filter (color wheel) can be effectively improved. Moreover, the light utilization efficiency can be increased so as to increase the brightness and contrast of the image projected onto the screen. Moreover, since in the present embodiment, the color filter 440 is an immovable part, the reliability thereof is better than the time-sequential filter (color wheel), which is moving part, used in the conventional technology. Besides, the manufacturing cost can be reduced, since the projection apparatus 400 in the present embodiment has simple structure.

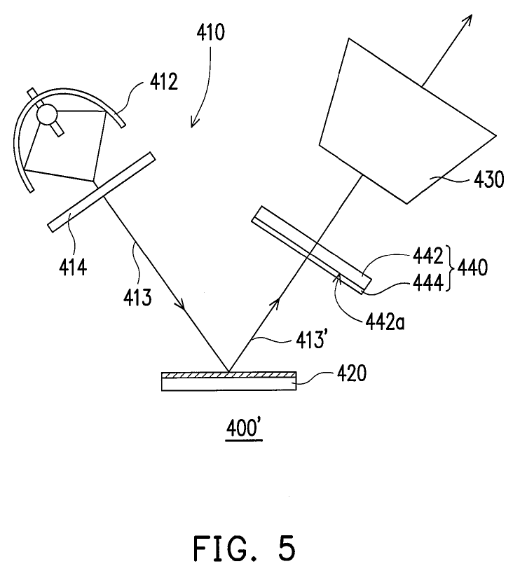

FIG. 5 is a diagram of a projection apparatus according to another embodiment of the present invention. FIG. 5 is similar to FIG. 3 and like reference numerals refer to like elements throughout. Referring to FIG. 5, in the present embodiment, the projection apparatus 400′ includes an illumination system 410, a reflective light valve 420, a projection lens 430, and a color filter 440. The illumination system 410 has a light source 412 for providing an illumination beam 413. The reflective light valve 420 is disposed on the transmission path of the illumination beam 413, and the reflective light valve 420 has a plurality of pixels 422 arranged in an array (as shown in FIG. 4A) for converting the illumination beam 413 into an image 413′. The projection lens 430 is disposed on the transmission path of the image 413′, and the color filter 440 is disposed between the reflective light valve 420 and the projection lens 430 and on the transmission path of the image 413′. The color filter 440 includes a transparent substrate 442 and a color filter array 444 disposed on a first surface 442a of the transparent substrate 442. The color filter array 444 includes a plurality of filter patterns 445 (as shown in FIG. 4B), and each of the filter patterns 445 corresponds to one of the foregoing pixels 422, respectively. In particular, the number of the filter patterns 445 is the same as the number of the pixels 422, and each of the filter patterns 445 corresponds to different pixel 422, and the lights reflected by the pixels 422 are projected to the filter patterns 445 corresponding to the pixels 422.

The major difference between the projection apparatus 400′ of the present embodiment and the projection apparatus 400 as shown in FIG. 3 is that the color filter 440 of the projection apparatus 400′ is disposed between the reflective light valve 420 and the projection lens 430. In other words, in the present embodiment, first the illumination beam 413 is converted into the image 413′ by the reflective light valve 420, and the image 413′ is adjusted into the required color by the color filter 440 so that the color of the image projected on the screen can be as expected.

The detailed description of the advantages, colors, material, formation method, and components of the filter patterns 445 of the projection apparatus in the present embodiment is similar to that of the embodiment described above, so will not be described here again.

In overview, the projection apparatus in the present invention has at least the following advantages:

1. In the present invention, the color filter can convert white light into lights of different colors at a sub-frame time, and these lights are simultaneously projected onto the corresponding pixels, thus, rainbow effect resulted from color wheel can be effectively improved and light utilization efficiency can be increased so as to increase the brightness and contrast of the image projected on the screen.

2. Because the color filter is an immovable part, and the color wheel used in conventional technology is a moving part, the color filter in the present invention has better reliability.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A projection apparatus, comprising:
an illumination system, having a light source for providing an illumination beam;
a reflective light valve, disposed on the transmission path of the illumination beam, the reflective light valve having a plurality of pixels arranged in an array for converting the illumination beam into an image;
a projection lens, disposed on the transmission path of the image;
a color filter, disposed between the light source and the reflective light valve and on the transmission path of the illumination beam, wherein the color filter comprises:
a transparent substrate; and
a color filter array, disposed on a first surface of the transparent substrate, wherein the color filter array comprises a plurality of filter patterns, and each of the filter patterns corresponds to one of the pixels, respectively.

2. The projection apparatus as claimed in claim 1, wherein the filter patterns comprise a plurality of first color filter patterns, a plurality of second color filter patterns, and a plurality of third color filter patterns.

3. The projection apparatus as claimed in claim 1, wherein the color filter further comprises an anti-reflection coating disposed on a second surface of the transparent substrate, and the second surface is opposite to the first surface.

4. The projection apparatus as claimed in claim 1, wherein the filter patterns comprise inorganic material.

5. The projection apparatus as claimed in claim 1, wherein the filter patterns comprise a plurality of stacked dichroic films or pigment material.

6. The projection apparatus as claimed in claim 1, wherein each of the filter patterns and each of the pixels are similar figures.

7. The projection apparatus as claimed in claim 6, wherein the illumination system further has a condenser disposed between the color filter and the reflective light valve, and the condenser is suitable for focusing the lights passed through the filter patterns of the color filter onto the corresponding pixels.

8. The projection apparatus as claimed in claim 1 further comprising a beam splitter disposed between the color filter, the reflective light valve, and the projection lens.

9. The projection apparatus as claimed in claim 1, wherein the reflective light valve comprises digital micro-mirror device or liquid crystal on silicon panel.

10. A projection apparatus, comprising:
an illumination system, having a light source for providing an illumination beam;
a reflective light valve, disposed on the transmission path of the illumination beam, the reflective light valve having a plurality of pixels arranged in an array for converting the illumination beam into an image;
a projection lens, disposed on the transmission path of the image;
a color filter, disposed between the reflective light valve and the projection lens and on the transmission path of the image, wherein the color filter comprises:
a transparent substrate; and
a color filter array, disposed on a first surface of the transparent substrate, the color filter array comprising a plurality of filter patterns, each of the filter patterns corresponding to one of the pixels, respectively.

11. The projection apparatus as claimed in claim 10, wherein the filter patterns comprise a plurality of first color filter patterns, a plurality of second color filter patterns, and a plurality of third color filter patterns.

12. The projection apparatus as claimed in claim 10, wherein the color filter further comprises an anti-reflection coating disposed on a second surface of the transparent substrate, and the second surface is opposite to the first surface.

13. The projection apparatus as claimed in claim 10, wherein the filter patterns comprise inorganic material.

14. The projection apparatus as claimed in claim 10, wherein the filter patterns comprise a plurality of stacked dichroic films or pigment material.

15. The projection apparatus as claimed in claim 10, wherein the reflective light valve comprises digital micro-mirror device or liquid crystal on silicon panel.
